(19) United States
(12) Patent Application Publication
(10) Pub. No.: US 2012/0045619 A1
(43) Pub. Date: Feb. 23, 2012

(54) SUBSTRATE PROVIDED WITH OPTICAL STRUCTURE AND OPTICAL ELEMENT USING THE SAME

(75) Inventors: Tomohiro ANDO, Tokyo (JP); Kenji MATSUMOTO, Tokyo (JP)

(73) Assignee: CITIZEN HOLDINGS CO., LTD., Tokyo (JP)

(21) Appl. No.: 13/213,159

(22) Filed: Aug. 19, 2011

(30) Foreign Application Priority Data
Aug. 20, 2010 (JP) 2010-184951

(51) Int. Cl. B32B 3/30; B29D 11/00; G02F 1/1333; G02B 1/04; G02B 3/08

(52) U.S. Cl. 428/161; 264/2.6

(57) ABSTRACT

The present invention provides a substrate provided with an optical structure which can correctly transfer the jagged shape of a mold and guarantee a lens surface that has favorable quality, and provides an optical element which uses such a substrate. A manufacturing method of a substrate, provided with an optical structure, includes applying a curing resin onto the substrate, which has a recessed portion, pressing a mold, having a jagged shape, from an upper portion of the curing resin toward the substrate, and forming an optical structure having the jagged shape by curing the curing resin. The recessed portion is provided to cover the lower portion of the region on which the jagged shape is arranged, so as to retain uncured resin of the curing resin when the mold is pressed toward the substrate. An optical element includes a substrate that is manufactured using the above-described manufacturing method.

This application is a new U.S. patent application that claims benefit of JP 2010-184951, filed on Aug. 20, 2010, the entire content of JP 2010-184951 is hereby incorporated by reference.

### FIELD OF THE INVENTION

The present invention relates to a substrate provided with an optical structure and an optical element which uses such a substrate.

### BACKGROUND OF THE INVENTION

In recent years, various types of lenses such as Fresnel lenses, constituting a thin optical structure formed from resin, have been in frequent use due to weight-reduction and cost-reduction demands.

However, in the case where a Fresnel lens is formed via a UV curing method using a mold, a problem exists with curling and wrinkling occurring in each optical structure constituting a Fresnel lens due to volume shrinkage that occurs during the curing of the resin.

To solve this problem, a Fresnel lens is known in which the volume for each pitch of the lens resin layer having a prismatic unit lens is formed evenly over every zone of the Fresnel lens (e.g., Patent Document 1).
Patent Document 1: JP H08-94808-A (FIG. 1, Pg. 2)

### SUMMARY OF THE INVENTION

The manufacturing method of a Fresnel lens will be discussed using FIG. 7. FIG. 7 shows explanatory drawings of an imprint (transfer) process of a Fresnel lens 50. Hereinbelow, an example of the use of a light-curing resin as an imprinting resin which is cured via ultraviolet rays (UV), visible light, or infrared light, will be described.

Firstly, as shown in FIG. 7(a), a light-curing resin 25 is drip-dispensed onto a transparent substrate 21 via a dispenser 60. Note that the surface of the transparent substrate 21 can be plasma-irradiated, surface modification can be performed on the transparent substrate 21 or a plasma process, etc., can be applied on the transparent substrate 21, beforehand. By applying either of such processes, in the case where the adhesion ability between the transparent substrate 21 and the resin 25 is poor, this adhesion ability can be improved by applying a such an adhesive layer.

Subsequently, as shown in FIGS. 7(b) and 7(c), the resin 25 which is drip-dispensed onto the transparent substrate 21 is pressed by a mold tool 70 while applying pressure thereon. An inverted jagged shape of the Fresnel lens 50 is formed in the mold tool 70. The releasing operation is carried out by applying a fluorine mold-release agent on the surface of the mold tool 70 beforehand.

Thereafter, with the resin 25 sufficiently entering into the gaps in the mold tool 70, the resin 25 is cured by irradiating ultraviolet rays 80 as shown in FIG. 7(c). Upon irradiating the ultraviolet rays 80, by providing a mask 75 on side of the transparent substrate 21 from which the ultraviolet rays 80 are irradiated, the ultraviolet rays 80 are only transmitted through the aperture portion of the mask 75, so that the resin 25 is cured at the shape defined by the aperture portion of the mask 75.

After the resin 25 is sufficiently cured, the mold tool 70 is released from the resin 25, as shown in FIG. 7(d), and the resin portion at which the ultraviolet rays was not irradiated due to the mask 75 is washed off using a solvent. According to the above process, the Fresnel lens 50 is transferred onto the surface of the transparent substrate 21, and a patterned imprinted resin layer 30 is formed by removing the outer resin portions.

However, the problem of curling and wrinkling occurring in each optical structure constituting a Fresnel lens could not be sufficiently solved by merely forming each pitch of the lens resin layer having prismatic unit lenses so that the volume thereof is constant for every zone of the Fresnel lens. In particular, in the case where an optical structure having a complicated structure is formed, there is the problem of the design thereof becoming even more complicated.

An objective of the present invention is to provide a substrate provided with an optical structure, which can solve the above-described problems, and to provide an optical element which uses such a substrate.

In addition, another objective of the present invention is to provide a substrate provided with an optical structure which can correctly transfer the jagged shape of the mold and guarantee a lens surface that has a favorably quality, and to provide an optical element which uses such a substrate.

A manufacturing method of a substrate provided with an optical structure, includes applying a curing resin onto the substrate, which has a recessed portion, pressing a mold, having a jagged shape, from an upper portion of the curing resin toward the substrate, and forming an optical structure having the jagged shape by curing the curing resin and wherein the recessed portion is provided to cover the lower portion of the region on which the jagged shape is arranged to retain uncured resin of the curing resin when the mold is pressed toward the substrate.

In the manufacturing method of the substrate provided with an optical structure, it is desirable for the jagged shape to be configured of a plurality of unit lenses that define a Fresnel lens.

In the manufacturing method of the substrate provided with an optical structure, it is desirable for the recessed portion to be arranged at a position corresponding to at least a part of the jagged shape of the optical structure.

In the manufacturing method of the substrate provided with an optical structure, it is desirable for the recessed portion to be arranged at a position corresponding to a location at which the thickness of the jagged shape of the optical structure is greatest.

In the manufacturing method of the substrate provided with an optical structure, it is desirable for the recessed portion to be arranged over the entire region at which the jagged shape of the optical structure is formed.

In the manufacturing method of the substrate provided with an optical structure, it is desirable for the volume of the recessed portion to be larger than the volume of the optical structure multiplied by the volume shrinkage of the curing resin.

In the manufacturing method of the substrate provided with an optical structure, it is desirable for the refractive index of the optical structure and the refractive index of the substrate to be the same.

In the manufacturing method of the substrate provided with an optical structure, it is desirable for the material of the optical structure and the material of the substrate to be the same.

In the manufacturing method of the substrate provided with an optical structure, it is desirable for the curing resin to be a light-curing resin, the substrate to be a transparent substrate, and for the light-curing resin to be cured by irradiating ultraviolet rays from the underside of the transparent substrate that is provided with the recessed portion.

In the manufacturing method of the substrate provided with an optical structure, it is desirable for the area of the sectional area of the recessed portion minus the curing shrinkage portion of the curing resin that is filled inside the recessed portion to be predetermined to be larger than the area of the curing shrinkage portion of the resin that is filled inside the jagged shape.

An optical element is characterized by a first substrate that is manufactured using the manufacturing method of the above described manufacturing method, and a second substrate; a liquid crystal layer provided in between the optical structure and the second substrate; and a seal material which is provided on the outer side of the optical structure and seals the liquid crystal layer that is provided in between the optical structure and the second substrate.

An optical element is characterized by a first substrate that is manufactured using the manufacturing method of the above described manufacturing method, and a second substrate, wherein the recessed portion is formed into a lens shape, and the refractive index of the optical structure and the refractive index of the first and second first transparent substrates are different from each other.

A method of manufacturing a substrate, provided with an optical structure having a jagged shape by curing curable resin that has been applied onto the substrate, is characterized by forming a recessed portion in the substrate on the side onto which the resin was applied at a location that corresponds to the jagged shape of the optical structure.

A substrate, provided on the upper surface thereof with an optical structure formed by curable resin and having a jagged surface, is characterized by forming a recessed portion in the substrate at a location that corresponds to the jagged shape of the optical structure. An optical element, in which liquid crystal is held between a pair of substrates, is characterized by using the above-described substrate for at least one of the pair of substrates.

In the method of manufacturing a substrate provided with an optical structure and in an optical element that used this substrate, since a recessed portion has been formed at a location that corresponds to the jagged shape of the optical structure, distortion of the lens surface that occurs during cure shrinkage of the optical structure that is formed by a curable resin can be reduced down to a negligible level.

### DESCRIPTION OF THE DRAWINGS

These and other features and advantages of the present invention will be better understood by reading the following detailed description, taken together with the drawings wherein:

FIG. 1(a) shows a sectional view of a substrate, and FIG. 1(b) is a plan view of the substrate.

FIGS. 2(a) through 2(d) show sectional views of a manufacturing method of an optical structure.

FIGS. 3(a) through 3(g) show modified embodiments of a recessed portion.

FIG. 4 shows another modified embodiment of the recessed portion.

FIG. 5(a) is a measurement diagram of a cross section of a Fresnel lens that was manufactured by the method shown in FIG. 7, and FIG. 5(b) is a measurement diagram of a cross section of a Fresnel lens that was manufactured by the method shown in FIG. 2.

FIG. 6(a) is a cross sectional view of a liquid crystal optical element, and FIG. 6(b) is a plan view showing the positional relationship between the Fresnel lens and the shape of the seal material.

FIGS. 7(a) through 7(d) show sectional views of an example of a manufacturing method of an optical structure.

### DETAILED DESCRIPTION OF THE PREFERRED EMBODIMENT

The following is a description of a manufacturing method of a substrate provided with an optical structure, and an liquid crystal optical element, with reference to the drawings. However, it should be understood that the present invention is not limited to the drawings or the embodiments disclosed herein.

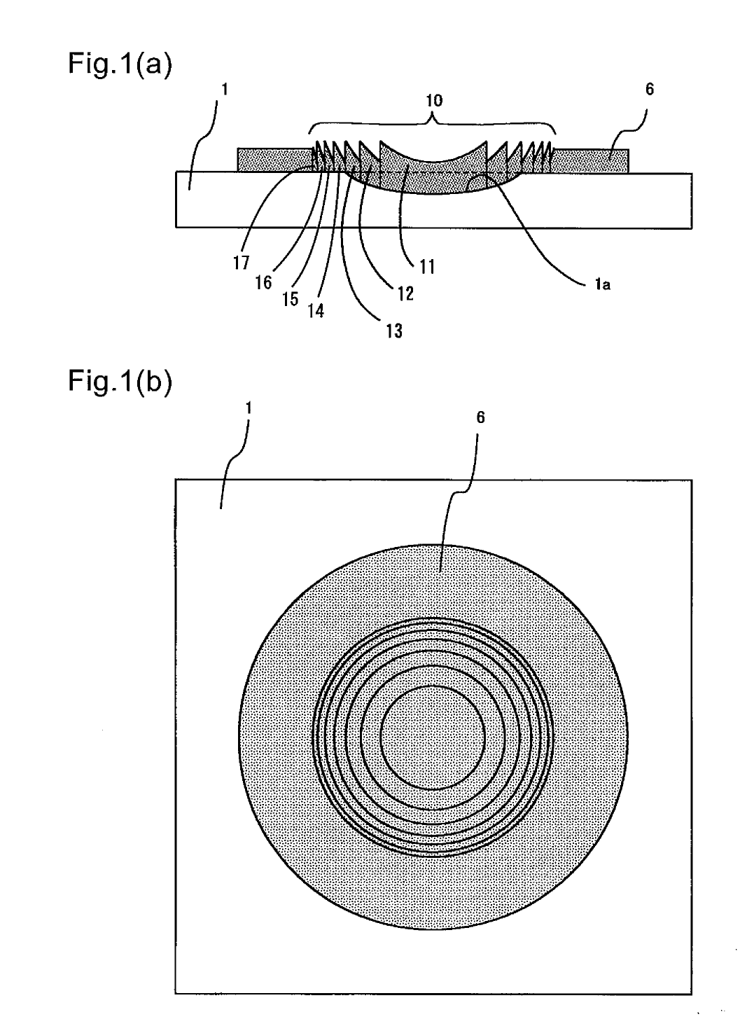

FIG. 1(a) shows a sectional view of a substrate, and FIG. 1(b) is a plan view of the substrate. For the sake of convenience, an aspect ratio that differs from the actual aspect ratio is schematically shown in FIG. 1. A light-curing resin “Lumiplus” (registered trademark) available from MITSUBISHI GAS CHEMICAL COMPANY, INC., was used as a transparent substrate 1. As shown in FIG. 1, an imprinted resin layer 6 with a Fresnel lens 10, constituting an optical structure, that is patterned on a portion thereof is provided on the transparent substrate 1. The material used for the imprinted resin layer 6 was the same as that of the transparent substrate 1. The Fresnel lens 10 has an equal blaze (zone) height (amount of sag) configured of seven unit lenses 11, 12, 13, 14, 15, 16 and 17 that form a jagged shape. The shapes of the prismatic unit lenses are disclosed in Table 1 hereinbelow.

TABLE 1

| | | | | Cross | |
|---|---|---|---|---|---|
| Prismatic | Pitch | Amount | Angle | Sectional | Volume |
| Unit Lens | (mm) | of Sag | (Degrees) | Area (mm²) | (mm³) |
| 11 | 3.635785 | 7 | 0.110311793 | 0.0127 | 0.15 |
| 12 | 1.533412 | 7 | 0.261552453 | 0.0054 | 0.15 |
| 13 | 1.203108 | 7 | 0.333358211 | 0.0042 | 0.15 |
| 14 | 1.044243 | 7 | 0.384071954 | 0.0037 | 0.16 |
| 15 | 0.955515 | 7 | 0.419735202 | 0.0033 | 0.17 |
| 16 | 0.907782 | 7 | 0.441804869 | 0.0032 | 0.18 |
| 17 | 0.7201474 | 7 | 0.556910746 | 0.0025 | 0.15 |

The pitch of the unit lens 11 indicates the distance from the center of the unit lens 11 to the periphery thereof, and the cross sectional area indicates the value of an approximate triangular shape of a sectional surface of the unit lens. Note that although the number and the shapes of the unit lenses indicated above are one example, the present invention is not limited thereto; another number and other shapes of the unit lens can be selected.

The base surface of each unit lens is coincident with the upper surface of the transparent substrate 1. Furthermore, for the sake of convenience, a boundary line for each unit lens is shown in the drawings, however, the imprinted resin layer 6 is integrally formed from the same material. At least one recessed portion 1a (which is a depression provided to cover the entire lower portion of the region on which the unit lenses 11 through 17, which constitute an optical structure, are arranged) that corresponds to the optical structure is formed in the transparent substrate 1. Part of the material that forms the Fresnel lens 10 fills the recessed portion 1a. Note that the recessed portion 1a can be a depression covering a larger region than that which includes the lower portion of the region on which the unit lenses 11 through 17 are arranged.

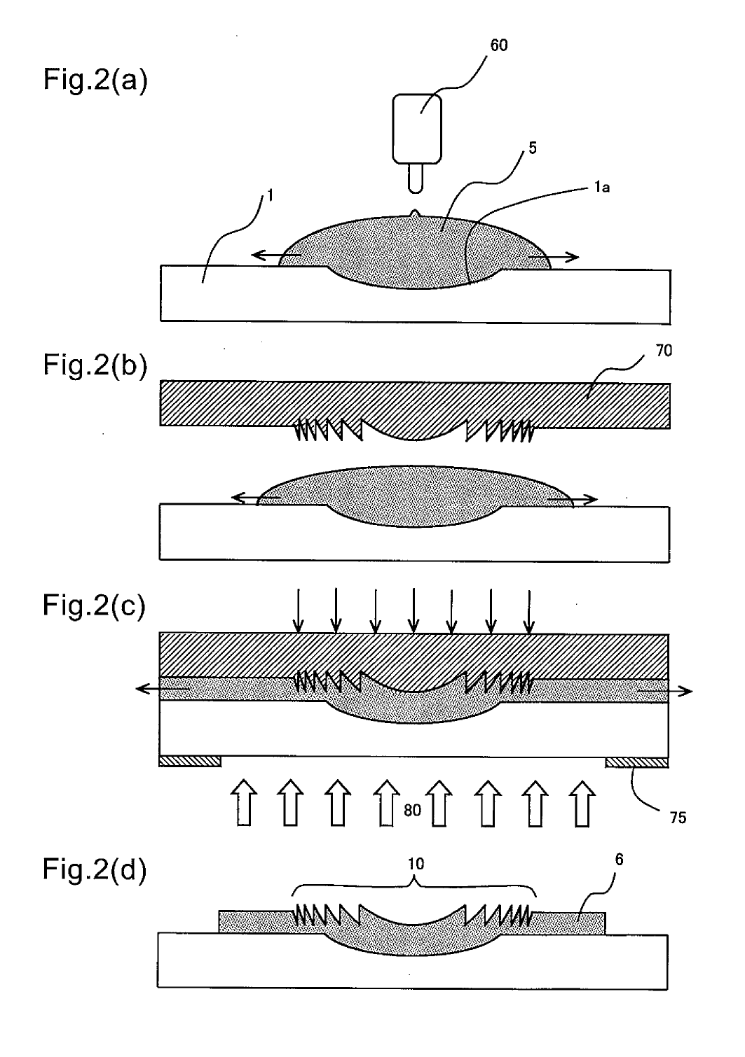

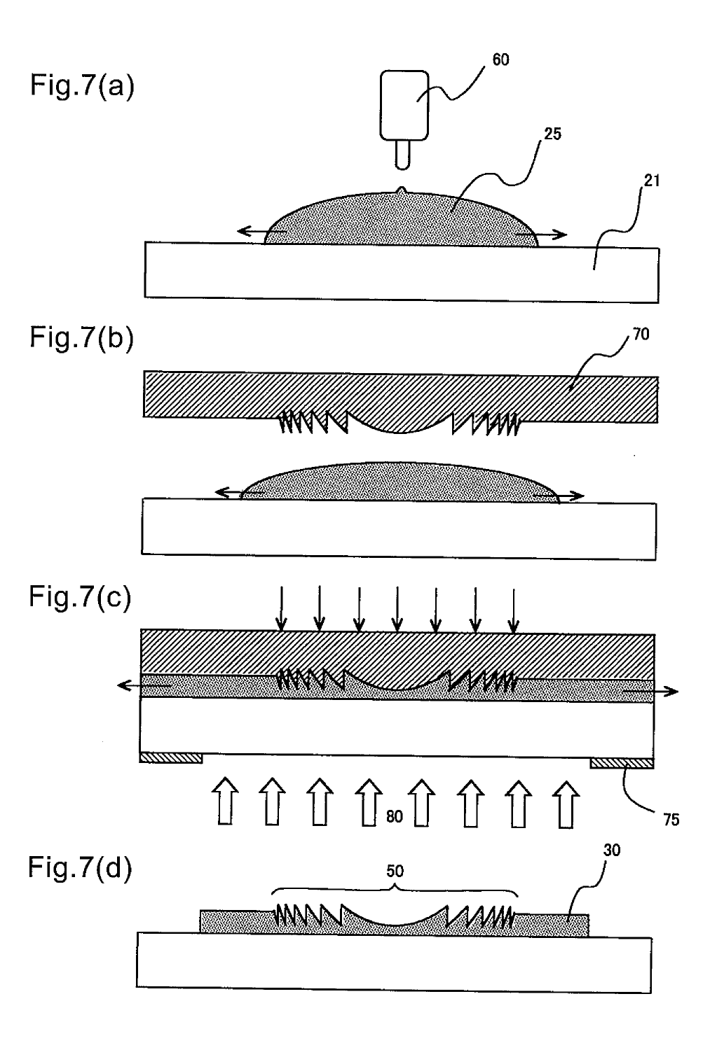

FIG. 2 shows sectional views of a manufacturing method of an optical structure that uses a substrate for use in an optical element. In FIG. 2, components which are the same as those shown in FIG. 7 are designated with the same reference designators and some of the explanations thereof are omitted.

Firstly, as shown in FIG. 2(a), the transparent substrate 1 having the recessed portion 1a is prepared.

Subsequently, an appropriate quantity of light-curing resin 5, e.g., “Lumiplus” (registered trademark) available from MITSUBISHI GAS CHEMICAL COMPANY, INC., which is the same material as that of the transparent substrate 1, is drip-dispensed onto the transparent substrate 1 via a dispenser 60. The resin 5 gradually spreads out from the center of the transparent substrate 1 toward the periphery thereof. Note that the recessed portion 1a of the transparent substrate 1 has been formed by being cast in a mold, however, the recessed portion 1a can be formed by injection molding or by a milling operation with a diamond turning tool. Furthermore, in the case where the transparent substrate 1 is formed of glass, the recessed portion 1a can be formed by chemical etching.

Subsequently, as shown in FIG. 2(b), a mold tool 70, formed with an inverted jagged shape of the Fresnel lens 10, is lowered toward the resin 5. As shown in FIG. 2(c), the mold tool 70 is pressed onto the resin while applying pressure thereon. During this stage, the resin 5 spreads toward the periphery thereof, however, an optimal amount of resin 5 that is drip-dispensed is predetermined so as not to flow out when put under pressure.

Note that although in FIG. 2 the widths of the mold tool 70 and the transparent substrate 1 are the same, in practice, the mold tool 70 is larger in order to facilitate mold releasing and to prevent resin from spreading around the mold tool 70. Note that if the diameter of the Fresnel lens 10 is small and the size of the transparent substrate 1 is large, the size of the mold tool 70 may be reduced.

Thereafter, with the resin 5 sufficiently entering into the gaps in the mold tool 70, the resin 5 is cured by irradiating ultraviolet rays 80 from below the transparent substrate 1. Upon irradiating the ultraviolet rays 80, since a mask 75 is provided on the side of the transparent substrate 1 from which the ultraviolet rays 80 are irradiated, the ultraviolet rays 80 are only transmitted through the aperture portion of the mask 75, so that the resin 5 is cured at the shape defined by the aperture portion of the mask 75.

The curing reaction of the resin 5 starts from the transparent substrate 1 at which the ultraviolet rays 80 is irradiated, and gradually progresses toward the resin 5 which is in contact with the mold tool 70. During this process, cure shrinkage occurs in the resin 5 in accordance with the progression of the curing reaction. The cured resin draws the uncured and half-cured resin, which surrounds the cured resin, due to the shrinkage of the cured resin at the recessed portion 1a of the transparent substrate 1. Furthermore, pressure is applied on the resin 5 even during cure shrinkage, so that the mold tool 70 is pushed so as to fill the gaps that occurred due to the cure shrinkage. By applying such a pressure, the uncured and half-cured resin 5 that exists in the recessed portion 1a act as a filler or a buffer, so that the resin 5 moves throughout every gap of the transferred shape of the mold tool 70. Accordingly, a beautifully-formed optical structure can be transferred which is formed by the transfer shape of the mold tool 70.

After the entire resin 5 is sufficiently cured, the mold tool 70 is released from the resin 5 as shown in FIG. 2(d), and uncured resin 5 that was not irradiated by the ultraviolet rays 80 due to the mask 75 is washed off with a solvent. According to the above process, the Fresnel lens 10 is transferred onto the transparent substrate 1 and the outer resin is removed so as to produce the patterned imprinted resin layer 6.

The recessed portion 1a can be provided over the entire region of the unit lenses 11 through 17 of the optical structure, however, it is desirable for the recessed portion 1a to be formed on the transparent substrate 1 at least at a location corresponding to where the sectional area is maximum, i.e., at a location at which the thickness of the optical structure is greatest. The volume of the recessed portion 1a is characterized as being at least larger than the volume of all of the unit lenses multiplied by the volume shrinkage of the resin 5. Specifically, the area of the sectional area of the recessed portion 1a minus the curing shrinkage portion of the resin that is filled inside the recessed portion 1a is predetermined to be larger than the area of the curing shrinkage portion of the resin that is filled inside all of the unit lenses.

The shape of the recessed portion 1a is spherical, the diameter of the recessed portion 1a is 15 mm (the diameter of the Fresnel lens 10 is 20 mm), the depth of the recessed portion 1a is 0.02 mm, and the sectional area of the recessed portion 1a is 15 mm². Note that the shape of the recessed portion 1a can be spherical, cylindrical, conical, cubic, rectangular, etc., or any other finely jagged shape. Furthermore, the above described values of the recessed portion 1a are merely one example and the recessed portion 1a is not limited thereto.

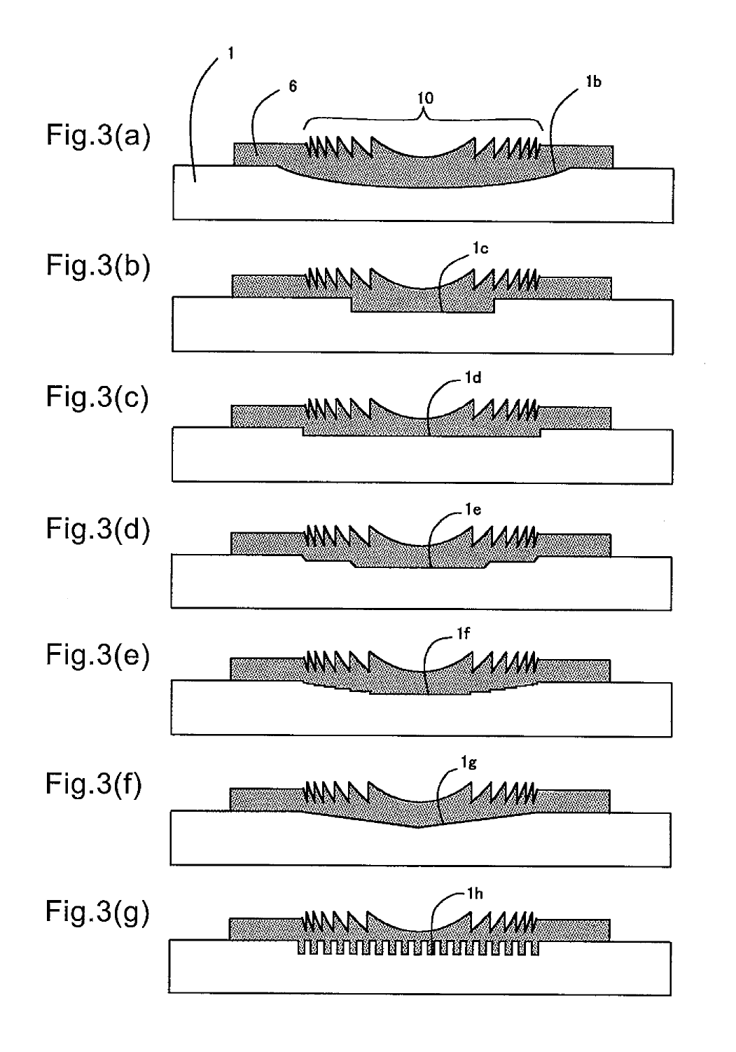

FIGS. 3(a) through 3(g) show modified embodiments of the recessed portion.

A recessed portion 1b shown in FIG. 3(a) is formed over the entire region of the Fresnel lens 10 and is wok-shaped. A recessed portion 1c shown in FIG. 3(b) is formed only over a partial region of the Fresnel lens 10 and is cylindrically shaped (i.e., the recessed portion 1c has a constant depth). The recessed portion 1c disclosed in FIG. 3(b) is set so as to correspond to the largest portion of the unit lenses that configure the Fresnel lens 10, i.e., at the location where the largest amount of cure shrinkage occurs. Furthermore, since a sufficient depth of the recessed portion 1c is provided, it is possible for an amount of resin that is sufficient for filling the curing shrinkage portion of the curing resin filled into the Fresnel lens 10 to accumulate in the recessed portion 1c.

A recessed portion 1d shown in FIG. 3(c) is formed over the entire region at which the Fresnel lens 10 is formed and has a cylindrical shape (i.e., the recessed portion 1d has a constant depth). Recessed portions 1e, if and 1g shown in FIGS. 3(d), 3(e) and 3(f) are each formed over the entire region of the Fresnel lens 10 and each has a shape that gradually increases in depth toward the center of the transparent substrate 1. A recessed portion 1h shown in FIG. 3(g) is formed over the entire region of the Fresnel lens 10 and is formed in a finely jagged shape (i.e., a plurality of concentric grooves are formed).

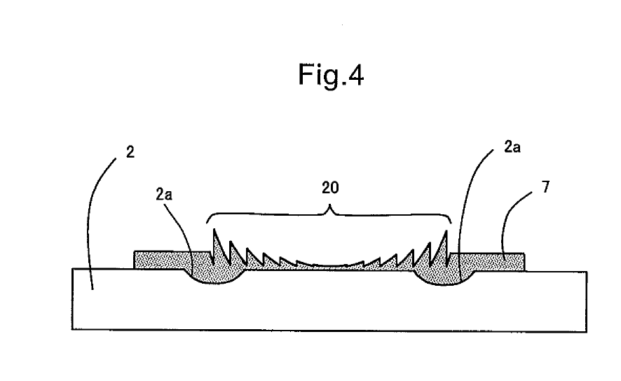

FIG. 4 shows another modified embodiment of the recessed portion.

In a Fresnel lens 20 shown in FIG. 4, the pitch of each blaze angle is equal, and the unit-lens volume is maximum at the peripheral portion; accordingly, a recessed portion 2a of a transparent substrate 2 is formed at a position corresponding to this peripheral portion. The recessed portion 2a has the form of an inside shape of one half of a doughnut cut into upper and lower halves.

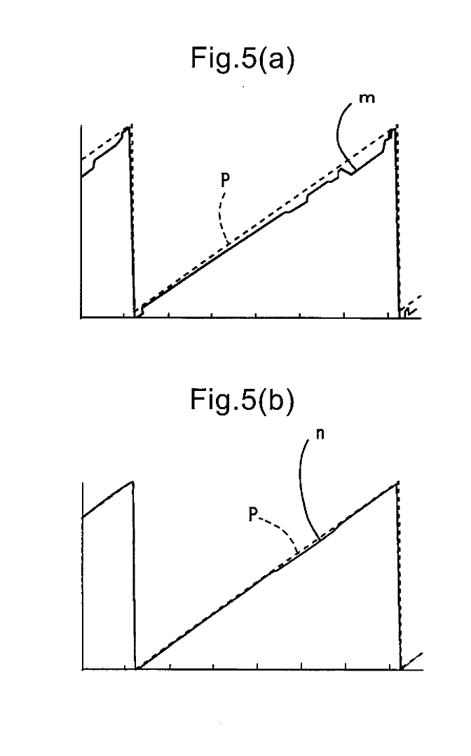

FIG. 5(a) is a measurement diagram of a cross section of a Fresnel lens that was manufactured by the method shown in FIG. 7, and FIG. 5(b) is a measurement diagram of a cross section of a Fresnel lens that was manufactured by the method shown in FIG. 2. Note that the same shaped mold was used in FIGS. 5(a) and 5(b) and the shape of the mold tool is indicated by a dotted line p.

FIG. 5(a) indicates the sectional shape m of a portion of the unit lenses that are included in the Fresnel lens in the reference example of an actual manufacturing method shown in FIG. 7. In the reference example of FIG. 5(a), NIF-A-1 (cure shrinkage of 9±2%) was used as a resin for forming the Fresnel lens.

Furthermore, FIG. 5(b) indicates the sectional shape n of a portion of the unit lenses that are included in the Fresnel lens in the embodiment of an actual manufacturing method shown in FIG. 2. In the embodiment of FIG. 5(a), likewise with that of FIG. 5(b), NIF-A-1 (cure shrinkage of 9±2%) was also used as a resin for forming the Fresnel lens.

In the case shown in FIG. 5(a), a large amount of error has occurred between the sectional shape m of the Fresnel lens and the shape of the mold tool that is indicated by a dotted line p. Whereas in the case shown in FIG. 5(b), the sectional shape n of the Fresnel lens and the mold tool that is indicated by a dotted line p are substantially the same, confirming that a favorable surface quality of the Fresnel lens can be achieved.

Since the recessed portion 1a is preformed in the transparent substrate 1 that is used in the manufacturing method shown in FIG. 2, in the case where the resin 5 has been drip-dispensed and pressed by the mold tool 70, the spreading of the resin 5 toward the periphery is restricted, so that some of the resin 5 remains in the center of the Fresnel lens 10. Accordingly, as shown in FIG. 5(b), transfer defects of the shape due to curing shrinkage of the resin 5 do not occur, so that the shape transfer of the mold tool 70 can be carried out with precision.

Even if high pressure is applied to the mold tool in order to reduce the thickness of the remaining resin layer from the substrate surface, the resin in the region of the recessed portion 1a does not flow out externally due to the effect of the recessed portion 1a, and hence, transfer defects caused by curing shrinkage do not occur, so that a favorable transfer can be performed. Note that it is possible to avoid the occurrence of a lens effect of the region of the recessed portion by making the refractive indexes of the substrate and the imprinted resin layer 6 the same. Whereas, a lens effect can be provided by making the refractive indexes of the transparent substrate 1 and the imprinted resin layer 6 differ. By making the diameter of the recessed portion smaller than the effective diameter of the Fresnel lens (e.g., see FIG. 2(d) and FIG. 3(b)), the flat portions of the mold tool and the substrate constitute a basis by which the Fresnel lens is imprinted in a more parallel manner with respect to the substrate.

Note that in the above descriptions have been given of an embodiment that uses the mold tool 70, however, it is possible to also use a silicon mold or a resin mold.

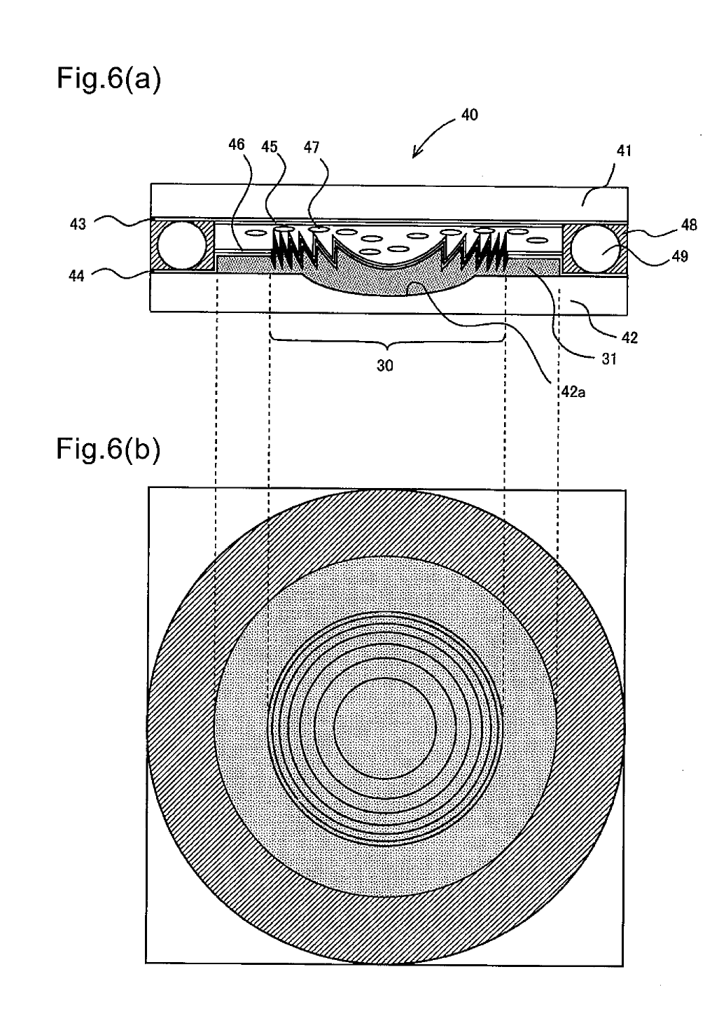

FIG. 6(a) is a cross sectional view of a liquid crystal optical element, and FIG. 6(b) is a plan view showing the positional relationship between the Fresnel lens and the shape of the seal material. For the sake of convenience, an aspect ratio that differs from the actual aspect ratio is schematically shown in FIG. 6.

As shown in FIG. 6(a), a liquid crystal optical element 40 is configured so that a first transparent substrate 41 and a second transparent substrate 42 bonded each other via a seal material 48 so that transparent electrodes 43 and 44 formed on the substrate surfaces, respectively, oppose each other.

A transparent electrode 43 and an oriented film 45 are formed on the first transparent substrate 41. An optical element substrate formed by the manufacturing method shown in FIG. 2 was used as the second transparent substrate 42. Accordingly, a recessed portion 42a, which is the same as the recessed portion 1a shown in FIG. 2, is formed in the second transparent substrate 42. An imprinted resin layer 31, to which an optical structure (Fresnel lens 30) is integrally formed via an imprinting (transfer) process, is provided in the liquid crystal optical element 40. A transparent electrode 44 and an oriented film 46 are formed on the second transparent substrate 42.

A spacer 49 is incorporated in the seal material 48, and a cell gap between the first transparent substrate 41 and the second transparent substrate 42 is restricted by the spacer 49. The seal material 48 is formed in an annular shape that encircles the Fresnel lens 30 that is concentric therewith, and a liquid crystal 47 is filled inside the seal material 48. The imprinted resin layer 31 and the seal material 48 are in contact with each other, and the area of the liquid crystal 47 is provided above the imprinted resin layer 31.

The manufacturing method of the liquid crystal optical element 40 will be described hereinbelow.

Firstly, the imprinted resin layer 31 is formed on the second transparent substrate 42 by the manufacturing method shown in FIG. 2.

Subsequently, the transparent electrode 44 is formed on the surface of the imprinted resin layer 31 using a sputtering method. It is preferable for an SiO₂ barrier layer, etc., to be provided on the imprinted resin layer 31, especially in the case where the second transparent substrate 42 is a plastic substrate. Furthermore, in order to prevent short-circuiting from occurring between the transparent electrode 43 and the transparent electrode 44, an SiO₂ insulation film layer, etc., is provided on at least one of the transparent electrodes 43 and 44.

Subsequently, the oriented film 46 is formed on the transparent electrode 44 that is provided on the surface of the imprinted resin layer 31. The oriented film 46 is formed using, e.g., a spray coater. A masking process is carried out on the substrate 42 using a mask in which an effective zone is formed as an aperture portion, and the oriented film material is discharged on top of the masking. Thereafter, the solvent of the oriented film is extracted via sintering, and is imidized depending on the type of oriented film, resulting in the completion of the oriented film 46.

Subsequently, the orientation direction of the liquid crystal can be controlled by carrying out an alignment treatment on the formed oriented film 46 using a rubbing method. Note that care is necessary in order not to incur damage on the Fresnel lens when pressing a rubbing cloth thereon. However, a favorable alignment treatment via the rubbing method can be carried out by optimizing each condition for the rubbing cloth, the roller rotational speed, and the rubbing pressure, etc., by selecting the imprinted resin material, and by carrying out a hard-coat treatment on the surface of the oriented film 46.

The transparent electrode 43 and the oriented film 45 are formed on the first transparent substrate 41 in a similar manner.

An oblique deposition method, for example, can be used as a forming method for the oriented film. An inorganic material such as, e.g., SiOₓ, etc., can be used as a deposition material. The column structure of the deposited film can be changed via the deposition angle, and hence via which the orientation direction of the liquid crystal can be controlled. In the oblique deposition method, the oriented film 45 can be formed in a non-contacting manner without incurring damage on the shape of the Fresnel lens 30.

Furthermore, after the oriented film is applied on the surface of the imprinted resin layer 31 via inkjet, spin coating, or spray coating, the oriented film can be formed using a photo-alignment method. Even if such a method is used, an oriented film 45 can be formed in a non-contacting manner without incurring damage on the shape of the Fresnel lens 30.

Subsequently, (after forming the transparent electrode 44 and the oriented film 46 on the surface of the imprinted resin layer 31) the seal material 48 is applied by a dispenser at a position where the imprinted resin layer 31 is not present. An ultraviolet curing resin can be used as the seal material 48. The seal material 48, with consideration of the seal material 48 being squashed and spreading, is not applied to the limit at the edge of the imprinted resin layer 31 but slightly inwards therefrom. In the bonding process of the first transparent substrate 41 and the second transparent substrate 42, described hereinbelow, the seal material 48 is squashed and bonds with the edge of the imprinted resin layer 31.

Subsequently, the liquid crystal 47 is drip-dispensed onto the area formed by the Fresnel lens 30 on the inner side of the seal material 48 using a dispenser. In order to prevent damage to the Fresnel lens 30, it is ideal to use a jet-dispenser which enables drip-dispensing in a non-contact manner. The amount of drip-dispensed liquid crystal 47 is determined according to the volume of the inside of the seal material 48.

The liquid crystal 47, which has been drip-dispersed at one location on the imprinted resin layer 31, is filled up higher than the seal material 48 in accordance with surface tension and wettability characteristics. In this state of the liquid crystal 47 being filled up higher than the seal material 48, when the first transparent substrate 41 and the second transparent substrate 42 are superimposed onto each other, there is a danger of the liquid crystal 47 spreading outside the seal material 48. Consequently, it is desirable to drip-dispense the liquid crystal 47 onto the imprinted resin layer 31 at a plurality of locations in order to reduce the height of the drip-dispensed liquid crystal 47.

Subsequently, (after the liquid crystal 47 has been drip-dispensed onto the imprinted resin layer 31) the liquid crystal drip-dispensed surface of the second transparent substrate 42 is faced upwards, and the first transparent substrate 41 and the second transparent substrate 42 are bonded to each other in a vacuum state. Thereafter, UV (ultraviolet) rays are irradiated on the seal material 48 from the imprinted resin layer 31 side so as to cure the seal material 48. After the ultraviolet rays are irradiated, the seal material 48 is completely cured by sintering as necessary. Hence the liquid crystal optical element 40 is manufactured according to the above-described process.

As described above, in the liquid crystal optical element 40, the second transparent substrate 42 is provided with the recessed portion 42a, and the shape of the Fresnel lens which is formed by the transfer shape of the mold tool can be formed with good precision. The liquid crystal optical element 40 can be used as a spectacle lens by machining each transparent substrate into a lens shape. For example, if a liquid cell structure is configured by a concave-shaped first transparent substrate 41 and a convex-shaped second transparent substrate 42, in addition to the lens characteristics, since the focal length can be varied by turning ON and OFF a voltage that is applied to the liquid crystal 47, a vari-focal electronic spectacle lens for use mainly in reading glasses can be obtained.

Note that in the above explanations, only a single Fresnel lens shape and a single liquid crystal optical element are shown in the drawings, however, the present invention is not limited thereto; a plurality of Fresnel lens shapes or liquid crystal optical elements can be concurrently manufactured. Note that in the above-described manufacturing method, even if a plurality of Fresnel lens shapes or liquid crystal optical elements are manufactured in consideration of productivity, the same effect can be effectively exhibited as that of a single product.

In FIG. 6, the transparent substrate 1 (see FIG. 1(a)) provided with the imprinted resin layer 6, in which the recessed portion 1a is formed and in which the Fresnel lens 10 is patterned on a part thereof, was used to manufacture the liquid crystal optical element 40. In this case, the resin is configured so that the refractive index of the transparent substrate 1 and the refractive index of the imprinted resin layer 6 are the same.

However, in the transparent substrate 1 shown in FIG. 1(a), it is possible to form a lens shape (concave lens shape) in the recessed portion 1a and configure the resin so that the refractive index of the transparent substrate 1 and the refractive index of the imprinted resin layer 6 are different. According to such a configuration, the transparent substrate 1 (see FIG. 1(a)) provided with the imprinted resin layer 6, in which the recessed portion 1a is formed and in which the Fresnel lens 10 is patterned on a part thereof, can itself be used as a lens (optical element) having an inherent lens and a Fresnel lens without using the liquid crystal layer 47 (see FIG. 6(a)).

What is claimed is:

1. A manufacturing method of a substrate provided with an optical structure, comprising:
applying a curing resin onto the substrate, which has a recessed portion;
pressing a mold, having a jagged shape, from an upper portion of said curing resin toward said substrate; and
forming an optical structure having said jagged shape by curing said curing resin,
wherein said recessed portion is provided to cover the lower portion of the region on which said jagged shape is arranged to retain uncured resin of said curing resin when said mold is pressed toward said substrate.

2. The manufacturing method of a substrate provided with an optical structure according to claim 1, wherein said jagged shape comprises a plurality of unit lenses that define a Fresnel lens.

3. The manufacturing method of a substrate provided with an optical structure according to claim 1, wherein said recessed portion is arranged at a position corresponding to at least a part of said jagged shape of said optical structure.

4. The manufacturing method of a substrate provided with an optical structure according to claim 1, wherein said recessed portion is arranged at a position corresponding to a location at which the thickness of said jagged shape of said optical structure is greatest.

5. The manufacturing method of a substrate provided with an optical structure according to claim 1, wherein said recessed portion is arranged over the entire region at which said jagged shape of said optical structure is formed.

6. The manufacturing method of a substrate provided with an optical structure according to claim 1, wherein the volume of said recessed portion is larger than the volume of said optical structure multiplied by the volume shrinkage of said curing resin.

7. The manufacturing method of a substrate provided with an optical structure according to claim 1, wherein the refractive index of said optical structure and the refractive index of said substrate are the same.

8. The manufacturing method of a substrate provided with an optical structure according to claim 1, wherein the material of said optical structure and the material of said substrate are the same.

9. The manufacturing method of a substrate provided with an optical structure according to claim 1, wherein said curing resin is a light-curing resin, said substrate is a transparent substrate, and wherein said light-curing resin is cured by irradiating ultraviolet rays from the underside of said transparent substrate that is provided with said recessed portion.

10. The manufacturing method of a substrate provided with an optical structure according to claim 1, wherein the area of the sectional area of said recessed portion minus the curing shrinkage portion of said curing resin that is filled inside said recessed portion is predetermined to be larger than the area of the curing shrinkage portion of the resin that is filled inside said jagged shape.

11. An optical element, comprising:
a first substrate that is manufactured using the manufacturing method of claim 1; and
a second substrate.

12. The optical element according to claim 11, further comprising:
a liquid crystal layer provided in between said optical structure and said second substrate; and
a seal material which is provided on the outer side of said optical structure and seals said liquid crystal layer that is provided in between said optical structure and said second substrate.

13. The optical element according to claim 11, wherein said recessed portion is formed into a lens shape, and wherein the refractive index of said optical structure and the refractive index of said first and second first transparent substrates are different from each other.
